(19) United States
(12) Patent Application Publication
(10) Pub. No.: US 2019/0239699 A1
(43) Pub. Date: Aug. 8, 2019

(54) GUACAMOLE KEEPER

(71) Applicant: Progressive International Corporation, Kent, WA (US)

(72) Inventor: Joseph Kent, Seattle, WA (US)

(73) Assignee: Progressive International Corporation, Kent, WA (US)

(21) Appl. No.: 16/259,843

(22) Filed: Jan. 28, 2019

Related U.S. Application Data
(60) Provisional application No. 62/626,278, filed on Feb. 5, 2018.

(51) Int. Cl. A47J 47/10; B65D 21/08; B65D 43/12; B65D 51/16

(52) U.S. Cl. CPC A47J 47/10; B65D 51/1672; B65D 43/12; B65D 21/086

(57) ABSTRACT

A guacamole keeper includes a container having an open top and a flared rim, with upwardly extending sidewalls to form an interior space for holding guacamole or other food items of a similar consistency. A removable lid is configured with a peripheral flange. The lid is sized and arranged to fit inside the vertical sidewalls of the container, with a flange engaging the interior sidewalls to form a seal. The lid can be pressed entirely or substantially to the base of the container, with the flange engaging the sidewalls throughout most or all of the travel between the top and the bottom of the container

### PRIORITY CLAIM

This application claims the benefit of U.S. provisional application No. 62/626,278 filed Feb. 5, 2018, the contents of which are incorporated by reference.

### FIELD OF THE INVENTION

The present invention relates to containers for storing food items.

### BACKGROUND OF THE INVENTION

Certain food items, such as guacamole, are subject to discoloration and other deterioration when stored in an environment which exposes them to oxygen. Even when covered with a lid or a plastic wrap, relatively small amounts of oxygen can produce unfavorable results in a short period of time. Unfortunately, standard storage container lids are configured to attach to an upper rim of a container, inherently leaving free space between the lid and the food item when the container is less than completely full.

Others have tried to reduce the interior airspace, but with complicated approaches. In one example, U.S. patent publication 2017/0174411 to Lonner et al. describes a container with a piston-type telescoping arrangement to reduce the size of the container itself, and therefore the interior airspace. Thus far, efforts to solve this problem have been met with failure or with mixed results.

### SUMMARY OF THE INVENTION

A preferred version of the guacamole keeper comprises a container having an open top and a flared rim. In one version, the container has a base and upwardly extending sidewalls that are substantially vertical or entirely vertical in relation to the horizontal base of the container. The base and sidewalls combine to form an interior space for holding guacamole or other food items of a similar consistency.

A removable lid is configured with a peripheral flange, preferably formed from an elastomeric material and extending circumferentially around the lid. The lid is sized and arranged to fit inside the vertical sidewalls of the container, with the flange engaging the interior sidewalls to form a seal. The lid can be pressed entirely or substantially to the base of the container, with the flange engaging the sidewalls throughout most or all of the travel between the top and the bottom of the container.

In one version, the upper side of the lid is formed with a central opening and has inwardly directed ledges that are raised above a floor of the lid by a distance sufficient to allow a user to grasp the ledge so that the ledge can serve as a handle for the lid.

In one example, the guacamole keeper includes a container having a lower base and an upper rim, with a sidewall extending upwardly between the lower base and the upper rim, the container being configured to support the lower base in a horizontal orientation on a horizontal surface. The sidewall is substantially vertical from a lower sidewall position to an upper sidewall position between the lower base and the upper rim when the container is supported on the horizontal surface, the lower base and the sidewall combining to form a container interior space, the sidewall having an interior sidewall surface.

In a preferred version, a lid is removably attachable to the container, the lid having an outer perimeter sized and shaped to frictionally abut the interior sidewall surface and to seal the container interior space when the lid is attached to the container, wherein the lid is moveable between the upper sidewall position and the lower sidewall position, the lid further being frictionally held in a sealing position against the interior sidewall surface at the upper sidewall position, the lower sidewall position, and a plurality of locations between the upper sidewall position and the lower sidewall position.

The lid may include a resilient seal attached to the outer perimeter of the lid. The resilient seal may further have an annular peripheral flange.

In some versions, the lid further includes a floor configured to face toward the base when the lid is attached to the container, the floor further being bowed toward the base when the lid is attached to the container.

The lid may also include a ledge positioned above the floor and separated from the floor by a ledge height, the ledge being configured to allow a user to grasp the ledge by inserting a finger between the ledge and the floor. In some examples, the ledge comprises a pair of ledges, including a first ledge and a second ledge. Preferably, the ledge comprises a first ledge and a diametrically opposing second ledge, each of the first ledge and the second ledge extending inwardly toward a center of the lid, the first ledge terminating in a first end and the second ledge terminating in a second end, the first end and the second end being separated from one another.

In some versions, the lid comprises a lid interior space defined between the floor and the ledge. The ledge may extend around the entire perimeter of the lid, leaving a central opening defined by the ledge.

### BRIEF DESCRIPTION OF THE DRAWINGS

Preferred and alternative examples of the present invention are described in detail below with reference to the following drawings.

FIG. 1 is a top perspective view of a preferred guacamole keeper, shown with a lid positioned atop a container.

FIG. 2 is an exploded view of the guacamole keeper of FIG. 1.

FIG. 3 is a side elevational view of a preferred guacamole keeper, with a lid attached at an upper position on the container.

FIG. 4 is a sectional view, shown through section plane 4-4 in FIG. 3.

FIG. 5 is a side elevational view of a preferred guacamole keeper, with the lid attached at a lower interior position and not visible.

FIG. 6 is a sectional view, shown through section plane 6-6 in FIG. 5

### DETAILED DESCRIPTION OF TIE PREFERRED EMBODIMENT

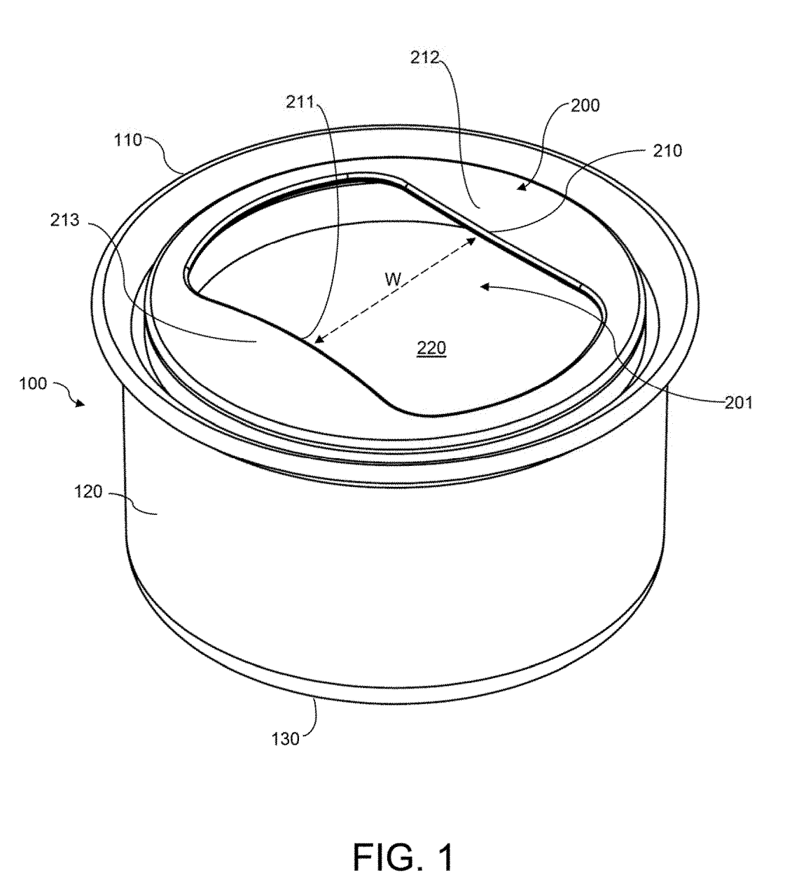

FIG. 1 illustrates a top perspective view of a preferred container for storing guacamole or similar food items. Although referred to as a guacamole keeper because that is a most-preferred use, it should be understood that it would be suitable for storing other food items despite this label. In the illustrated example, the guacamole keeper includes a container 100 and a lid 200 positioned atop the container to seal the interior of the container.

The container preferably has a base 130 defining a bottom of the container, and in one version the container is substantially cylindrical and has generally upright or vertical sidewalls 120 extending upward from the base to define an interior space. Most preferably, the sidewalls terminate in an upper rim 110, and in the illustrated example the upper rim is flared radially outwardly from the sidewalls which otherwise form a cylinder other than at the flared upper rim and optionally other than at a transitional location adjacent the base.

The preferred lid 200 is sized and configured to seal the interior of the container, and as seen in FIG. 1 the lid includes a pair of diametrically opposed ledges 212, 213 extending from a perimeter of the lid toward the center of the lid. The ledges terminate at ends 210, 211 that are spaced apart from one another by a width W which is preferably wide enough to allow a user to insert several fingers of a hand. In one version the width W is at least two inches or at least three inches. The opening between the ledges allows access to a floor 220 of the lid, which is separated from and positioned below the ledges to define a lid interior space 201. In one version, the ledge extends inwardly from the outer perimeter continuously along the entire outer perimeter.

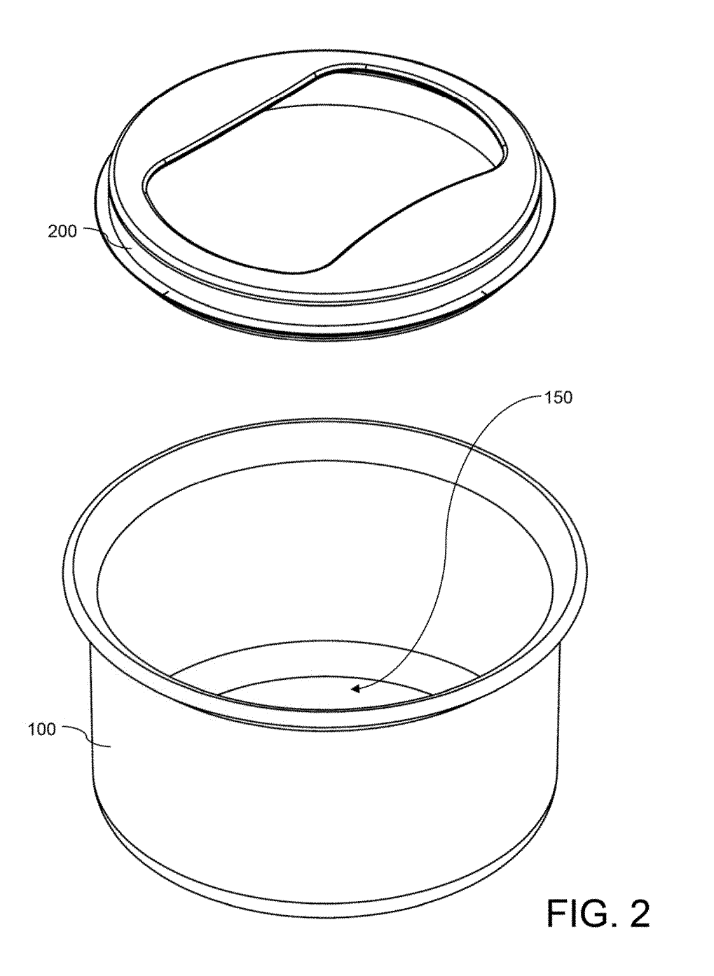

FIG. 2 illustrates an exploded perspective view of the guacamole keeper, showing the lid 200 removed from the container 100, and indicating the interior space 150 of the container.

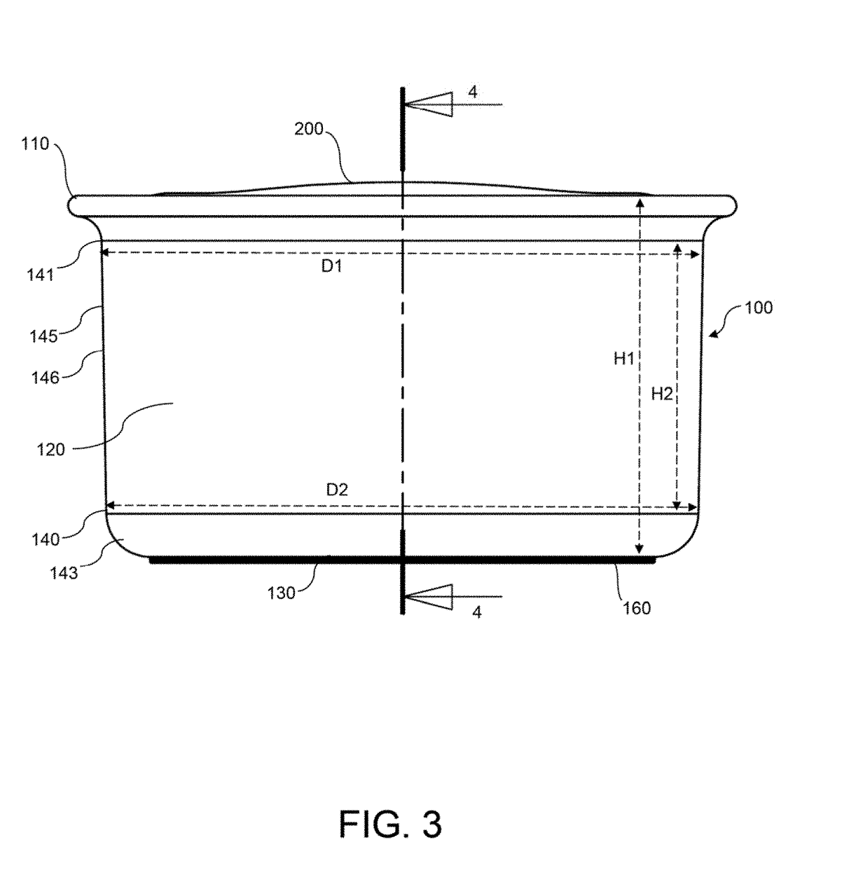

FIG. 3 is a front elevational view of the guacamole keeper, with sectional plane 4-4 indicating a vertical section taken through the combined container and lid, with the lid 200 placed in the container 100 at an upper position on the container. In this case, a small portion of the lid 200 is visible above the rim 110 of the container 100.

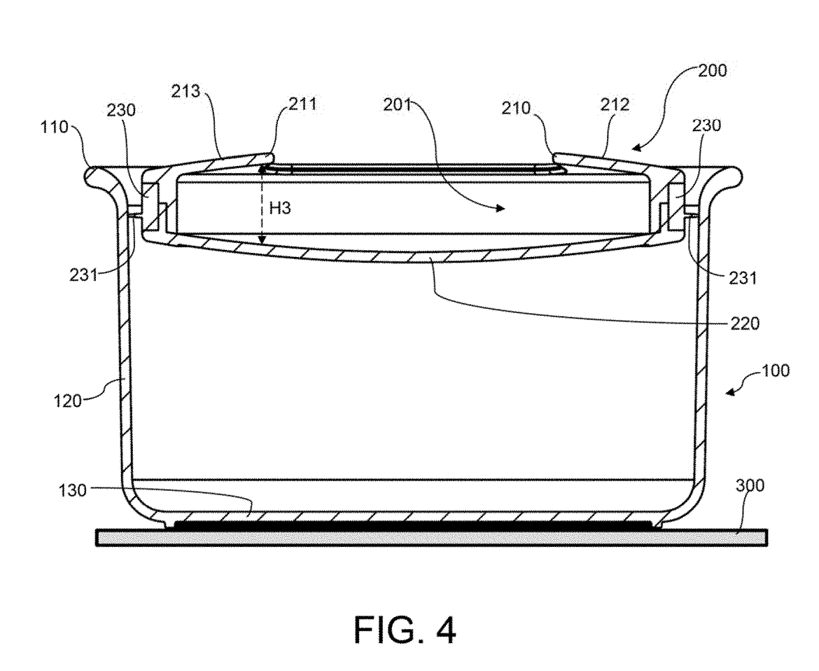

The preferred container includes a lower foundation 160, such as an annular footing to support the container on a horizontal surface 300 such as a countertop (see FIG. 4). In one version, the perimeter of the container at the bottom is formed with a rounded corner 143 as the base 130 of the container turns vertical. The sidewalls 120 of the container are substantially vertical between a lower position 140 near the base and an upper position 141 near the flared upper rim 110. In one version, 90 percent or more of the height H1 of the container is vertically sided, extending for the height H2 between the lower position 140 and the upper position 141. In other versions, at least 80 percent, or at least 70 percent of the container has substantially straight sidewalls in the central portion of the container.

As used in this description, “substantially” straight sidewalls means that the upper diameter D1 and the lower diameter D2 are within four percent of one another in length, and more preferably within three percent and most preferably within two percent of one another in length. In one example, D2 is slightly shorter than D1, and is about 98% of the length of D1.

FIG. 4 illustrates a sectional view of a preferred guacamole keeper, taken along section plane 4-4 from FIG. 3. This sectional view illustrates the preferred construction of the lid and the interior space 201 of the lid.

In the illustrated example, the lid includes a floor 220 which preferably has a bowed or concave shape in which the center of the lid is closer to the base of the container than a perimeter of the lid when the lid is placed atop the container. As described above, the lid includes a pair of diametrically opposed ledges 212, 213 terminating at ends 210, 211 opposite one another and allowing a hand to be inserted into the open space 201 to grab the lid for removal or raising it. Each ledge at the endpoint extends above the floor 220 for a height H3 which is preferably great enough for a user to inset one or more fingers into the space defined between the ledge and the floor of the lid, and in one version the height H3 is at least an inch.

In one version, the lid is surrounded by a resilient seal 230 which is annular or otherwise extends all the way around the circular perimeter of the lid in the preferred version. The seal terminates in a radial flange 231 extending radially outwardly, and which is preferably tapered to narrow as it extends outward. The seal may be formed from flexible or resilient materials such as silicone or other elastomers, or may alternatively be formed from plastics or similar materials and which may rely on the thickness or thinness of the seal and flange to provide a seal between the lid and the container.

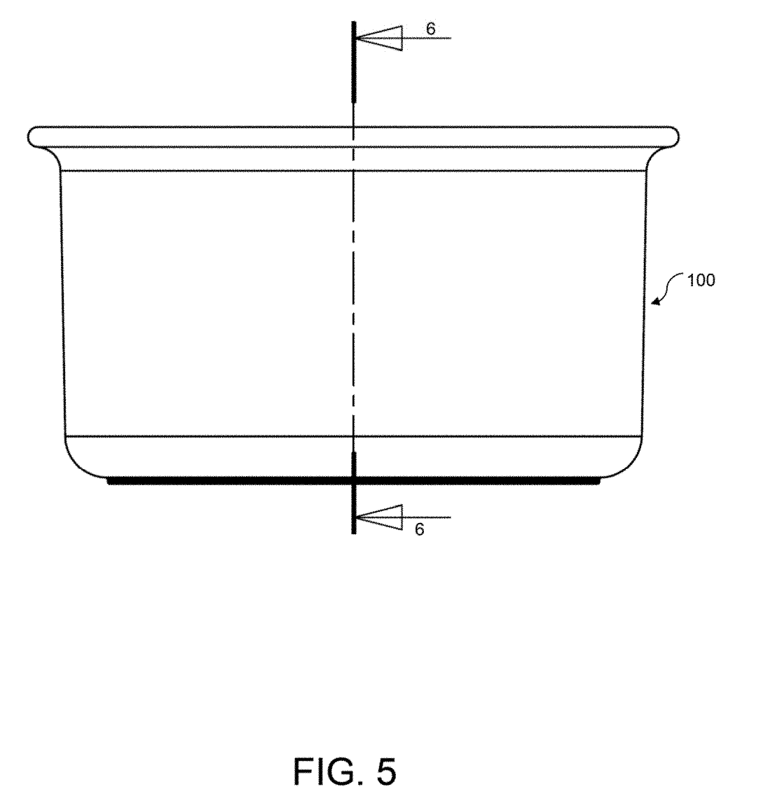

FIG. 5 illustrates a front elevational view as in FIG. 3, but in this case the lid has been pushed down into the container below the rim of the container 100, so that the lid is not visible in this view. Sectional plane 6-6 indicates a plane take through the combined container and lid along a vertical plane through the center.

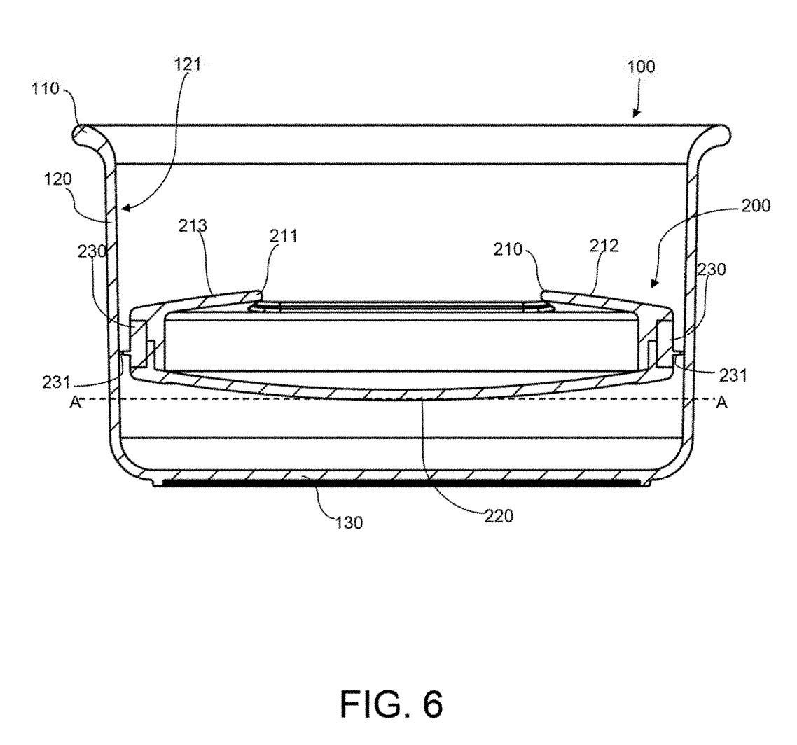

FIG. 6 is a sectional view taken along plane 6-6 from FIG. 5, and is essentially the same as FIG. 4 except that the lid 200 has been pushed downward into the container 100. As is seen in FIG. 6, a seal is formed between the lid 200 and the container 100 by the engagement of the seal 230 and its flange 231 against the interior surface 121 of the sidewall 120 of the container. As also seen in FIG. 6, the central portion of the lower surface or floor 220 of the lid is bowed outwardly and is lower than the perimeter of the lid. As such, the center of the lid is tangential to a horizontal plane A-A while the perimeter is positioned above the plane A-A.

The lid may be attached to the container at several locations, in which the perimeter of the lid abuts the interior sidewall to seal the container. With reference to FIG. 3, the lid may be frictionally held in place, for example, at a lower sidewall position 140, an upper sidewall position 141, or at a plurality of intermediate locations, e.g., 145, 146. In each case, the lid is frictionally and sealingly held in place.

In use, guacamole or a similar food item is placed into the container for use from the container. When a remaining amount is ready to be stored, the lid is placed atop the container and pressed downward until the floor 220 of the lid engages the guacamole within the container and pushes the guacamole downward. Preferably the lid is continued to be pressed downward against the guacamole until the air in the container is expelled, leaving the floor of the lid resting firmly against the top surface of the guacamole with as little interior air remaining as possible.

The lid may be removed by grasping one of the ledges and pulling upward for access to the guacamole. For continued storage, the lid can be positioned within the container again and pressed downward as described above.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims.

I claim:

1. A guacamole keeper, comprising:
a container having a lower base and an upper rim, with a sidewall extending upwardly between the lower base and the upper rim, the container being configured to support the lower base in a horizontal orientation on a horizontal surface;
the sidewall being substantially vertical from a lower sidewall position to an upper sidewall position between the lower base and the upper rim when the container is supported on the horizontal surface, the lower base and the sidewall combining to form a container interior space, the sidewall having an interior sidewall surface; and
a lid removably attachable to the container, the lid further having an outer perimeter sized and shaped to frictionally abut the interior sidewall surface and to seal the container interior space when the lid is attached to the container;
wherein the lid is moveable between the upper sidewall position and the lower sidewall position, the lid further being frictionally held in a sealing position against the interior sidewall surface at the upper sidewall position, the lower sidewall position, and a plurality of locations between the upper sidewall position and the lower sidewall position.

2. The guacamole keeper of claim 1, wherein the lid further comprises a resilient seal attached to the outer perimeter of the lid.

3. The guacamole keeper of claim 2, wherein the resilient seal further comprises a peripheral flange.

4. The guacamole keeper of claim 1, wherein the lid further comprises a floor configured to face toward the base when the lid is attached to the container, the floor further being bowed toward the base when the lid is attached to the container.

5. The guacamole keeper of claim 4, wherein the lid further comprises a resilient seal attached to the outer perimeter of the lid.

6. The guacamole keeper of claim 1, wherein the lid further comprises:
a floor configured to face toward the base when the lid is attached to the container; and
a ledge positioned above the floor and separated from the floor by a ledge height, the ledge being configured to allow a user to grasp the ledge by inserting a finger between the ledge and the floor.

7. The guacamole keeper of claim 6, wherein the ledge comprises a pair of ledges, including a first ledge and a second ledge.

8. The guacamole keeper of claim 6, wherein the ledge comprises a first ledge and a diametrically opposing second ledge, each of the first ledge and the second ledge extending inwardly toward a center of the lid, the first ledge terminating in a first end and the second ledge terminating in a second end, the first end and the second end being separated from one another.

9. The guacamole keeper of claim 8, wherein the lid comprises a lid interior space defined between the floor and the ledge.

10. The guacamole keeper of claim 9, wherein the floor is bowed toward the base when the lid is attached to the container.

11. The guacamole keeper of claim 10, wherein the lid further comprises a resilient seal attached to the outer perimeter of the lid.

12. A guacamole keeper, comprising:
a container having a lower base and an upper rim, with a sidewall extending upwardly from the lower base and the upper rim, the sidewall having an interior sidewall surface, the lower base and the sidewall combining to form a container interior space;
a lid removably attachable to the container, the lid having an outer perimeter sized and shaped to frictionally abut the interior sidewall surface and to seal the container interior space when the lid is attached to the container;
the lid further having a floor configured to face toward the base when the lid is attached to the container, and a ledge positioned above the floor and separated from the floor by a ledge height to define a lid interior space, the ledge being configured to allow a user to grasp the ledge by inserting a finger into the lid interior space;
wherein the lid is moveable between an upper sidewall position and a lower sidewall position, the lid further being frictionally held in a sealing position against the interior sidewall surface at the upper sidewall position, the lower sidewall position, and a plurality of locations between the upper sidewall position and the lower sidewall position.

13. The guacamole keeper of claim 12, wherein the ledge comprises a first ledge and a second ledge, each of the first ledge and the second ledge extending inwardly toward a center of the lid, the first ledge terminating in a first end and the second ledge terminating in a second end, the first end and the second end being separated from one another.

14. The guacamole keeper of claim 13, wherein the first ledge is positioned diametrically opposite from the second ledge.

15. The guacamole keeper of claim 13, wherein the floor is bowed toward the base when the lid is attached to the container.

16. The guacamole keeper of claim 15, wherein the lid further comprises a resilient seal attached to the outer perimeter of the lid, the resilient seal having a radial flange.

17. The guacamole keeper of claim 12, wherein the ledge extends inwardly from the outer perimeter continuously along the entire outer perimeter.

18. The guacamole keeper of claim 12, wherein the container is substantially cylindrical.

19. The guacamole keeper of claim 18, wherein the upper rim is flared outwardly.

20. The guacamole keeper of claim 18, wherein the lower base is rounded at a juncture of the lower base and the sidewall.
